(19) United States
(12) Patent Application Publication
(10) Pub. No.: US 2022/0383762 A1
(43) Pub. Date: Dec. 1, 2022

(54) INCREASING AWARENESS OF AN ENVIRONMENTAL CONDITION FOR AN UNMANNED AERIAL VEHICLE

(71) Applicant: SKYGRID, LLC, AUSTIN, TX (US)

(72) Inventors: SYED MOHAMMAD ALI, LEANDER, TX (US); LOWELL L. DUKE, AUSTIN, TX (US); ZEHRA AKBAR, LEANDER, TX (US); SYED MOHAMMAD AMIR HUSAIN, GEORGETOWN, TX (US); TAYLOR R. SCHMIDT, AUSTIN, TX (US); MILTON LOPEZ, ROUND ROCK, TX (US); RAVI TEJA PINNAMANENI, AUSTIN, TX (US)

(21) Appl. No.: 17/732,670

(22) Filed: Apr. 29, 2022

Related U.S. Application Data
(60) Provisional application No. 63/194,800, filed on May 28, 2021.

(51) Int. Cl. G08G 5/00

(52) U.S. Cl. CPC G08G 5/0069; G08G 5/0008

(57) ABSTRACT

Methods, systems, apparatuses, and computer program products for increasing awareness of an environmental condition for an unmanned aerial vehicle (UAV) are disclosed. In a particular embodiment, a method of increasing awareness of an environmental condition for a UAV includes an environmental awareness controller utilizing data associated with a first UAV to detect an environmental condition at a location associated with the first UAV. In this embodiment, the environmental awareness controller also updates environmental condition information associated with the location to indicate detection of the environmental condition at the location and provides the updated environmental condition information to a device associated with second UAV.

### CROSS-REFERENCE TO RELATED APPLICATIONS

This application is a non-provisional application for patent entitled to a filing date and claiming the benefit of earlier-filed U.S. Provisional Patent Application Ser. No. 63/194,800, filed May 28, 2021, the contents of which are incorporated by reference herein in their entirety.

### BACKGROUND

An Unmanned Aerial Vehicle (UAV) is a term used to describe an aircraft with no pilot on-board the aircraft. The use of UAVs is growing in an unprecedented rate, and it is envisioned that UAVs will become commonly used for package delivery and passenger air taxis. However, as UAVs become more prevalent in the airspace, there is a need to regulate air traffic and ensure the safe navigation of the UAVs.

The Unmanned Aircraft System Traffic Management (UTM) is an initiative sponsored by the Federal Aviation Administration (FAA) to enable multiple beyond visual line-of-sight drone operations at low altitudes (under (400) feet above ground level (AGL) in airspace where FAA air traffic services are not provided. However, a framework that extends beyond the (400) feet AGL limit is needed. For example, unmanned aircraft that would be used by package delivery services and air taxis may need to travel at altitudes above (400) feet. Such a framework requires technology that will allow the FAA to safely regulate unmanned aircraft.

### SUMMARY

Methods, systems, apparatuses, and computer program products for increasing awareness of an environmental condition for an unmanned aerial vehicle (UAV) are disclosed. In a particular embodiment, a method of increasing awareness of an environmental condition for a UAV includes an environmental awareness controller utilizing data associated with a first UAV to detect an environmental condition at a location associated with the first UAV. In this embodiment, the environmental awareness controller also updates environmental condition information associated with the location to indicate detection of the environmental condition at the location and provides the updated environmental condition information to a device associated with a second UAV.

In another embodiment, a method of increasing awareness of an environmental condition for a UAV includes an environmental awareness controller receiving from a device associated with a first UAV, a request for environmental condition information for a location. In this embodiment, the environmental awareness controller retrieves the environmental condition information from a repository of environmental condition information that indicates environmental conditions detected based on data associated with one or more other UAVs. According to this embodiment, the environmental awareness controller also provides the environmental condition information to the device associated with the first UAV.

As will be explained below, understanding the environmental conditions that a UAV may experience during a mission is important and, in some cases, may be pivotal in determining the success or failure of the mission. While land and space-based systems may provide useful information in this regard, the sensor data from UAVs operating in an area may be more accurate, precise, and relevant in preparing environmental condition information for another UAV operator or controller. By using this sensor data from one UAV to inform another operator, user, or device controlling another UAV, the environmental awareness of that second UAV operator, user, or device is improved and thus the chances of that second UAV successfully completing a mission is improved.

The foregoing and other objects, features, and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a block diagram illustrating a particular implementation of a system of increasing awareness of an environmental condition for an unmanned aerial vehicle (UAV) according to at least one embodiment of the present invention;

FIG. 2 is a block diagram illustrating a particular implementation of a system of increasing awareness of an environmental condition for a UAV according to at least one embodiment of the present invention;

FIG. 3A a block diagram illustrating a particular implementation of the blockchain used by the systems of FIGS. 1-2 to record data associated with an unmanned aerial vehicle;

FIG. 3B is an additional view of the blockchain of FIG. 3A;

FIG. 3C is an additional view of the blockchain of FIG. 3A;

FIG. 4 sets forth a block diagram illustrating another implementation of a system increasing awareness of an environmental condition for UAVs;

FIG. 5 is a block diagram illustrating a particular implementation of a method of increasing awareness of an environmental condition for a UAV according to at least one embodiment of the present invention;

FIG. 6 is a block diagram illustrating a particular implementation of a method of increasing awareness of an environmental condition for a UAV according to at least one embodiment of the present invention;

FIG. 7 is a block diagram illustrating a particular implementation of a method of increasing awareness of an environmental condition for a UAV according to at least one embodiment of the present invention;

FIG. 8 is a block diagram illustrating a particular implementation of a method of increasing awareness of an environmental condition for a UAV according to at least one embodiment of the present invention;

FIG. 9 is a block diagram illustrating a particular implementation of a method of increasing awareness of an environmental condition for a UAV according to at least one embodiment of the present invention; and

FIG. 10 is a block diagram illustrating a particular implementation of a method of increasing awareness of an environmental condition for a UAV according to at least one embodiment of the present invention.

### DETAILED DESCRIPTION

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

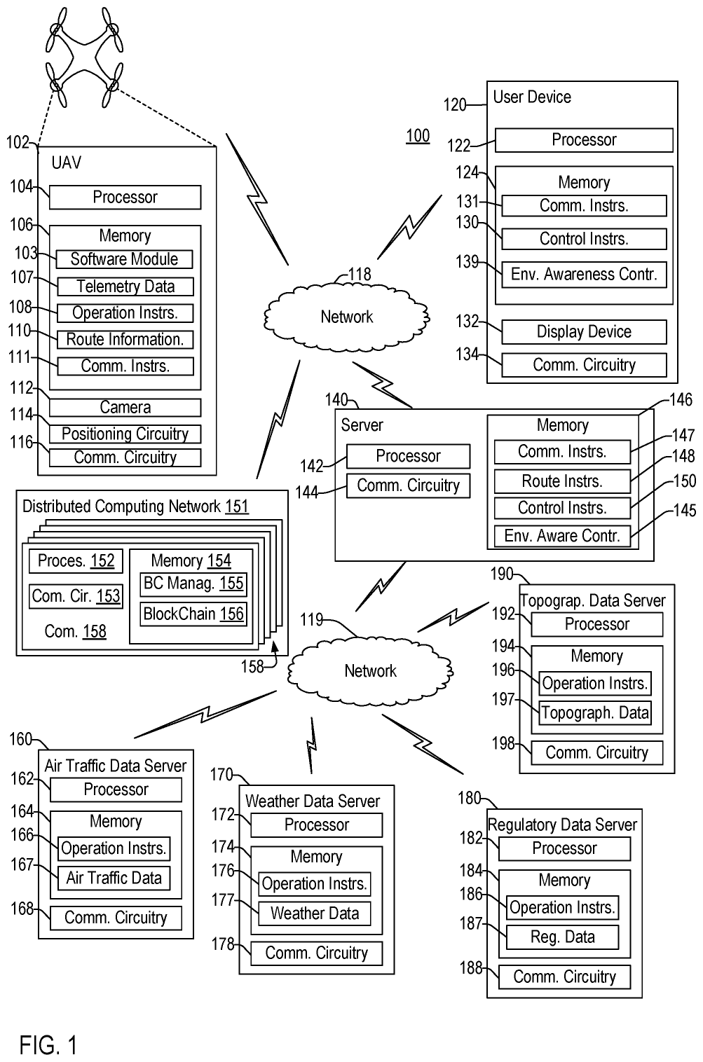

Exemplary methods, apparatuses, and computer program products of increasing awareness of an environmental condition for a UAV in accordance with the present invention are described with reference to the accompanying drawings, beginning with FIG. 1. FIG. 1 sets forth a diagram of a system 100 configured of increasing awareness of an environmental condition for a UAV according to embodiments of the present disclosure. The system 100 of FIG. 1 includes an unmanned aerial vehicle (UAV) 102, a user device 120, a server 140, a distributed computing network 151, an air traffic data server 160, a weather data server 170, a regulatory data server 180, and a topographic data server 190.

A UAV, commonly known as a drone, is a type of powered aerial vehicle that does not carry a human operator and uses aerodynamic forces to provide vehicle lift. UAVs are a component of an unmanned aircraft system (UAS), which typically include at least a UAV, a control device, and a system of communications between the two. The flight of a UAV may operate with various levels of autonomy including under remote control by a human operator or autonomously by onboard or ground computers. Although a UAV may not include a human operator pilot, some UAVs, such as passenger drones (drone taxi, flying taxi, or pilotless helicopter) carry human passengers.

For ease of illustration, the UAV 102 is illustrated as one type of drone. However, any type of UAV may be used in accordance with embodiments of the present disclosure and unless otherwise noted, any reference to a UAV in this application is meant to encompass all types of UAVs. Readers of skill in the art will realize that the type of drone that is selected for a particular mission or excursion may depend on many factors, including but not limited to the type of payload that the UAV is required to carry, the distance that the UAV must travel to complete its assignment, and the types of terrain and obstacles that are anticipated during the assignment.

In FIG. 1, the UAV 102 includes a processor 104 coupled to a memory 106, a camera 112, positioning circuitry 114, and communication circuitry 116. The communication circuitry 116 includes a transmitter and a receiver or a combination thereof (e.g., a transceiver). In a particular implementation, the communication circuitry 116 (or the processor 104) is configured to encrypt outgoing message(s) using a private key associated with the UAV 102 and to decrypt incoming message(s) using a public key of a device (e.g., the user device 120 or the server 140 that sent the incoming message(s). As will be explained further below, the outgoing and incoming messages may be transaction messages that include information associated with the UAV. Thus, in this implementation, communications between the UAV 102, the user device 120, and the server 140 are secure and trustworthy (e.g., authenticated).

The camera 112 is configured to capture image(s), video, or both, and can be used as part of a computer vision system. For example, the camera 112 may capture images or video and provide the video or images to a pilot of the UAV 102 to aid with navigation. Additionally, or alternatively, the camera 112 may be configured to capture images or video to be used by the processor 104 during performance of one or more operations, such as a landing operation, a takeoff operation, or object/collision avoidance, as non-limiting examples. Although a single camera 112 is shown in FIG. 1, in alternative implementations more and/or different sensors may be used (e.g., infrared, LIDAR, SONAR, etc.).

The positioning circuitry 114 is configured to determine a position of the UAV 102 before, during, and/or after flight. For example, the positioning circuitry 114 may include a global positioning system (GPS) interface or sensor that determines GPS coordinates of the UAV 102. The positioning circuitry 114 may also include gyroscope(s), accelerometer(s), pressure sensor(s), other sensors, or a combination thereof, that may be used to determine the position of the UAV 102.

The processor 104 is configured to execute instructions stored in and retrieved from the memory 106 to perform various operations. For example, the instructions include operation instructions 108 that include instructions or code that cause the UAV 102 to perform flight control operations. The flight control operations may include any operations associated with causing the UAV to fly from an origin to a destination. For example, the flight control operations may include operations to cause the UAV to fly along a designated route (e.g., based on route information 110, as further described herein), to perform operations based on control data received from one or more control devices, to take off, land, hover, change altitude, change pitch/yaw/roll angles, or any other flight-related operations. The UAV 102 may include one or more actuators, such as one or more flight control actuators, one or more thrust actuators, etc., and execution of the operation instructions 108 may cause the processor 104 to control the one or more actuators to perform the flight control operations. The one or more actuators may include one or more electrical actuators, one or more magnetic actuators, one or more hydraulic actuators, one or more pneumatic actuators, one or more other actuators, or a combination thereof.

The route information 110 may indicate a flight path for the UAV 102 to follow. For example, the route information 110 may specify a starting point (e.g., an origin) and an ending point (e.g., a destination) for the UAV 102. Additionally, the route information may also indicate a plurality of waypoints, zones, areas, regions between the starting point and the ending point.

The route information 110 may also indicate a corresponding set of control devices for various points, zones, regions, areas of the flight path. The indicated sets of control devices may be associated with a pilot (and optionally one or more backup pilots) assigned to have control over the UAV 102 while the UAV 102 is in each zone. The route information 110 may also indicate time periods during which the UAV is scheduled to be in each of the zones (and thus time periods assigned to each pilot or set of pilots).

The memory 106 of the UAV 102 may also include communication instructions 111 that when executed by the processor 104 cause the processor 104 to transmit to the distributed computing network 151, transaction messages that include telemetry data 107. Telemetry data may include any information that could be useful to identifying the location of the UAV, the operating parameters of the UAV, or the status of the UAV. Examples of telemetry data include but are not limited to GPS coordinates, instrument readings (e.g., airspeed, altitude, altimeter, turn, heading, vertical speed, attitude, turn and slip), and operational readings (e.g., pressure gauge, fuel gauge, battery level).

In the example of FIG. 1, the memory 106 of the UAV 102 further includes at least one UAV software module 103. The UAV software module 103 is defined as a group of computer executable code that, when executed by a processor, enables at least one specialized functionality of a UAV that may not normally be present on the UAV. For example, in the embodiment of FIG. 1, the camera 112 may normally be configured to take pictures. The UAV software module 103 may be executed by processor 104 to enable additional functionality of the camera 112, such as object detection or tracking. The UAV software module 103 may work in conjunction with the existing hardware of the UAV 102, such as shown in FIG. 1, or in other examples, the UAV software module 103 may work in conjunction with optional hardware. For example, a UAV software module 103 may work in combination with a sensor not normally present on the UAV 102. In such examples, adding the sensor to the UAV 102 may only be enabled once the appropriate software module is enabled. Likewise, the UAV software module 103 may not be functional unless the additional sensor is present on the UAV 103. Examples of functionality that may be enabled by a software module include, but are not limited to, object detection, automated flight patterns, object tracking, object counting, or responses to object detection.

The user device 120 includes a processor 122 coupled to a memory 124, a display device 132, and communication circuitry 134. The display device 132 may be a liquid crystal display (LCD) screen, a touch screen, another type of display device, or a combination thereof. The communication circuitry 134 includes a transmitter and a receiver or a combination thereof (e.g., a transceiver). In a particular implementation, the communication circuitry 134 (or the processor 122 is configured to encrypt outgoing message(s) using a private key associated with the user device 120 and to decrypt incoming message(s) using a public key of a device (e.g., the UAV 102 or the server 140 that sent the incoming message(s). Thus, in this implementation, communication between the UAV 102, the user device 120, and the server 140 are secure and trustworthy (e.g., authenticated).

The processor 122 is configured to execute instructions from the memory 124 to perform various operations. The instructions include control instructions 130 that include instructions or code that cause the user device 120 to generate control data to transmit to the UAV 102 to enable the user device 120 to control one or more operations of the UAV 102 during a particular time period, as further described herein.

In the example of FIG. 1, the memory 124 of the user device 120 also includes communication instructions 131 that when executed by the processor 122 cause the processor 122 to transmit to the distributed computing network 151, messages that include control instructions 130 that are directed to the UAV 102. In a particular embodiment, the transaction messages are also transmitted to the UAV and the UAV takes action (e.g., adjusting flight operations), based on the information (e.g., control data) in the message.

In addition, the memory 124 of the user device 120 may also include an environmental awareness controller 139. In a particular embodiment, the environmental awareness controller 139 includes computer program instructions that when executed by the processor 122 cause the processor 122 to carry out the operations of utilizing data associated with a first UAV to detect an environmental condition at a location associated with the first UAV; updating environmental condition information associated with the location to indicate detection of the environmental condition at the location; and providing the updated environmental condition information to a second UAV. In another embodiment, the environmental awareness controller 139 includes computer program instructions that when executed by the processor 122 cause the processor 122 to carry out the operations of receiving from a first UAV, a request for environmental condition information for a location; retrieving the environmental condition information from a repository of environmental condition information that indicates environmental conditions detected based on data associated with one or more other UAVs; and providing the environmental condition information to a device associated with the first UAV.

The server 140 includes a processor 142 coupled to a memory 146, and communication circuitry 144. The communication circuitry 144 includes a transmitter and a receiver or a combination thereof (e.g., a transceiver). In a particular implementation, the communication circuitry 144 (or the processor 142 is configured to encrypt outgoing message(s) using a private key associated with the server 140 and to decrypt incoming message(s) using a public key of a device (e.g., the UAV 102 or the user device 120 that sent the incoming message(s). As will be explained further below, the outgoing and incoming messages may be transaction messages that include information associated with the UAV. Thus, in this implementation, communication between the UAV 102, the user device 120, and the server 140 are secure and trustworthy (e.g., authenticated).

The processor 142 is configured to execute instructions from the memory 146 to perform various operations. The instructions include route instructions 148 comprising computer program instructions for aggregating data from disparate data servers, virtualizing the data in a map, generating a cost model for paths traversed in the map, and autonomously selecting the optimal route for the UAV based on the cost model. For example, the route instructions 148 are configured to partition a map of a region into geographic cells, calculate a cost for each geographic cell, wherein the cost is a sum of a plurality of weighted factors, determine a plurality of flight paths for the UAV from a first location on the map to a second location on the map, wherein each flight path traverses a set of geographic cells, determine a cost for each flight path based on the total cost of the set of geographic cells traversed, and select, in dependence upon the total cost of each flight path, an optimal flight path from the plurality of flight paths. The route instructions 148 are further configured to obtain data from one or more data servers regarding one or more geographic cells, calculate, in dependence upon the received data, an updated cost for each geographic cell traversed by a current flight path, calculate a cost for each geographic cell traversed by at least one alternative flight path from the first location to the second location, determine that at least one alternative flight path has a total cost that is less than the total cost of the current flight path, and select a new optimal flight path from the at least one alternative flight paths. The route instructions 148 may also include instructions for storing the parameters of the selected optimal flight path as route information 110. For example, the route information may include waypoints marked by GPS coordinates, arrival times for waypoints, pilot assignments.

The instructions may also include control instructions 150 that include instructions or code that cause the server 140 to generate control data to transmit to the UAV 102 to enable the server 140 to control one or more operations of the UAV 102 during a particular time period, as further described herein.

In addition, the memory 146 of the server 140 may also include an environmental awareness controller 145. In a particular embodiment, the environmental awareness controller 145 includes computer program instructions that when executed by the processor 142 cause the processor 142 to carry out the operations of utilizing data associated with a first UAV to detect an environmental condition at a location associated with the first UAV; updating environmental condition information associated with the location to indicate detection of the environmental condition at the location; and providing the updated environmental condition information to a second UAV. In another embodiment, the environmental awareness controller 145 includes computer program instructions that when executed by the processor 122 cause the processor 142 to carry out the operations of receiving from a first UAV, a request for environmental condition information for a location; retrieving the environmental condition information from a repository of environmental condition information that indicates environmental conditions detected based on data associated with one or more other UAVs; and providing the environmental condition information to a device associated with the first UAV.

In the example of FIG. 1, the memory 146 of the server 140 also includes communication instructions 147 that when executed by the processor 142 cause the processor 142 to transmit to the distributed computing network 151, transaction messages that include control instructions 150 that are directed to the UAV 102.

The distributed computing network 151 of FIG. 1 includes a plurality of computers. An example computer 158 of the plurality of computers is shown and includes a processor 152 coupled to a memory 154, and communication circuitry 153. The communication circuitry 153 includes a transmitter and a receiver or a combination thereof (e.g., a transceiver). In a particular implementation, the communication circuitry 153 (or the processor 152 is configured to encrypt outgoing message(s) using a private key associated with the computer 158 and to decrypt incoming message(s) using a public key of a device (e.g., the UAV 102, the user device 120, or the server 140 that sent the incoming message(s). As will be explained further below, the outgoing and incoming messages may be transaction messages that include information associated with the UAV 102. Thus, in this implementation, communication between the UAV 102, the user device 120, the server 140, and the distributed computing network 151 are secure and trustworthy (e.g., authenticated).

The processor 152 is configured to execute instructions from the memory 154 to perform various operations. The memory 154 includes a blockchain manager 155 that includes computer program instructions for utilizing an unmanned aerial vehicle for emergency response. Specifically, the blockchain manager 155 includes computer program instructions that when executed by the processor 152 cause the processor 152 to receive a transaction message associated with a UAV. For example, the blockchain manager may receive transaction messages from the UAV 102, the user device 120, or the server 140. The blockchain manager 155 also includes computer program instructions that when executed by the processor 152 cause the processor 152 to use the information within the transaction message to create a block of data; and store the created block of data in a blockchain data structure 156 associated with the UAV 102.

The blockchain manager may also include instructions for accessing information regarding an unmanned aerial vehicle (UAV). For example, the blockchain manager 155 also includes computer program instructions that when executed by the processor 152 cause the processor to receive from a device, a request for information regarding the UAV; in response to receiving the request, retrieve from a blockchain data structure associated with the UAV, data associated with the information requested; and based on the retrieved data, respond to the device.

The UAV 102, the user device 120, and the server 140 are communicatively coupled via a network 118. For example, the network 118 may include a satellite network or another type of network that enables wireless communication between the UAV 102, the user device 120, the server 140, and the distributed computing network 151. In an alternative implementation, the user device 120 and the server 140 communicate with the UAV 102 via separate networks (e.g., separate short-range networks.

In some situations, minimal (or no) manual control of the UAV 102 may be performed, and the UAV 102 may travel from the origin to the destination without incident. In some examples, a UAV software module may enable the minimal (or no) manual control operation of the UAV 102. However, in some situations, one or more pilots may control the UAV 102 during a time period, such as to perform object avoidance or to compensate for an improper UAV operation. In some situations, the UAV 102 may be temporarily stopped, such as during an emergency condition, for recharging, for refueling, to avoid adverse weather conditions, responsive to one or more status indicators from the UAV 102, etc. In some implementations, due to the unscheduled stop, the route information 110 may be updated (e.g., via a subsequent blockchain entry, as further described herein) by route instructions 148 executing on the UAV 102, the user device 120, or the server 140). The updated route information may include updated waypoints, updated time periods, and updated pilot assignments.

In a particular implementation, the route information is exchanged using a blockchain data structure. The blockchain data structure may be shared in a distributed manner across a plurality of devices of the system 100, such as the UAV 102, the user device 120, the server 140, and any other control devices or UAVs in the system 100. In a particular implementation, each of the devices of the system 100 stores an instance of the blockchain data structure in a local memory of the respective device. In other implementations, each of the devices of the system 100 stores a portion of the shared blockchain data structure and each portion is replicated across multiple devices of the system 100 in a manner that maintains security of the shared blockchain data structure as a public (i.e., available to other devices) and incorruptible (or tamper evident) ledger. Alternatively, as in FIG. 1, the blockchain data structure 156 is stored in a distributed manner in the distributed computing network 151.

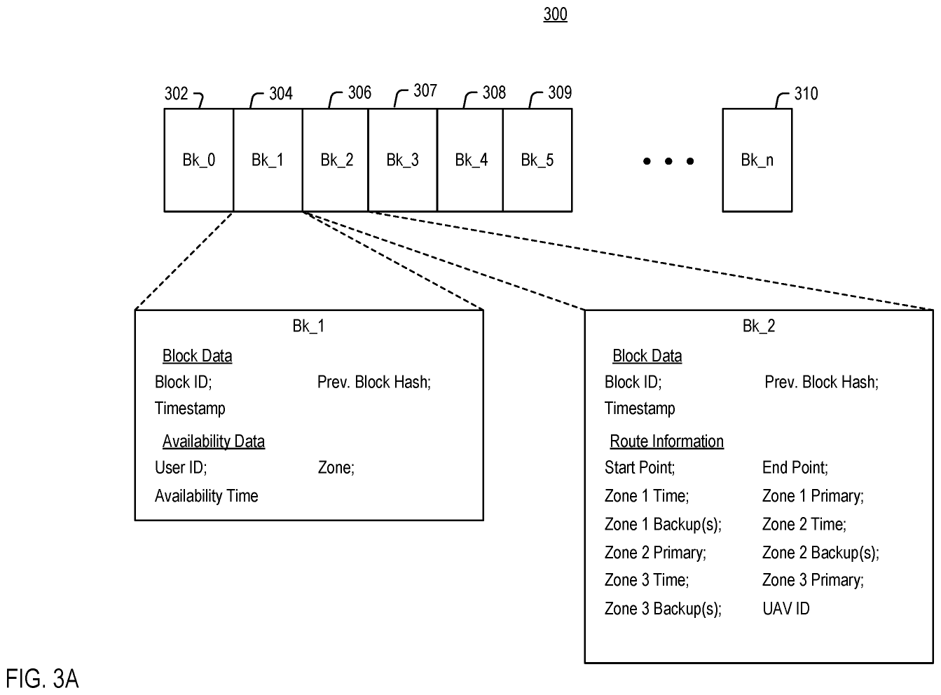

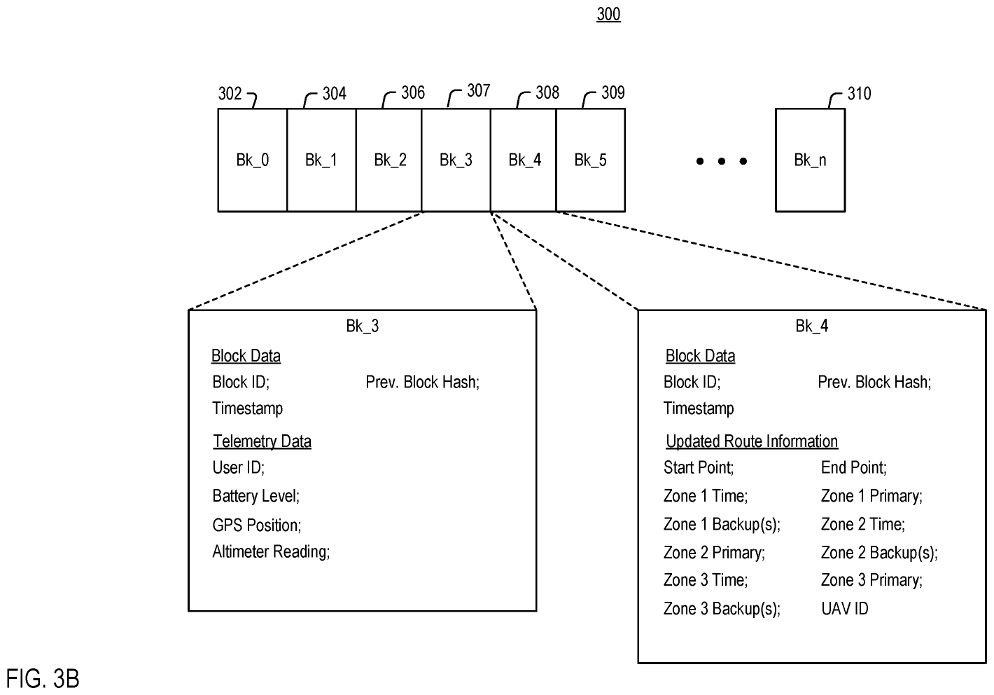

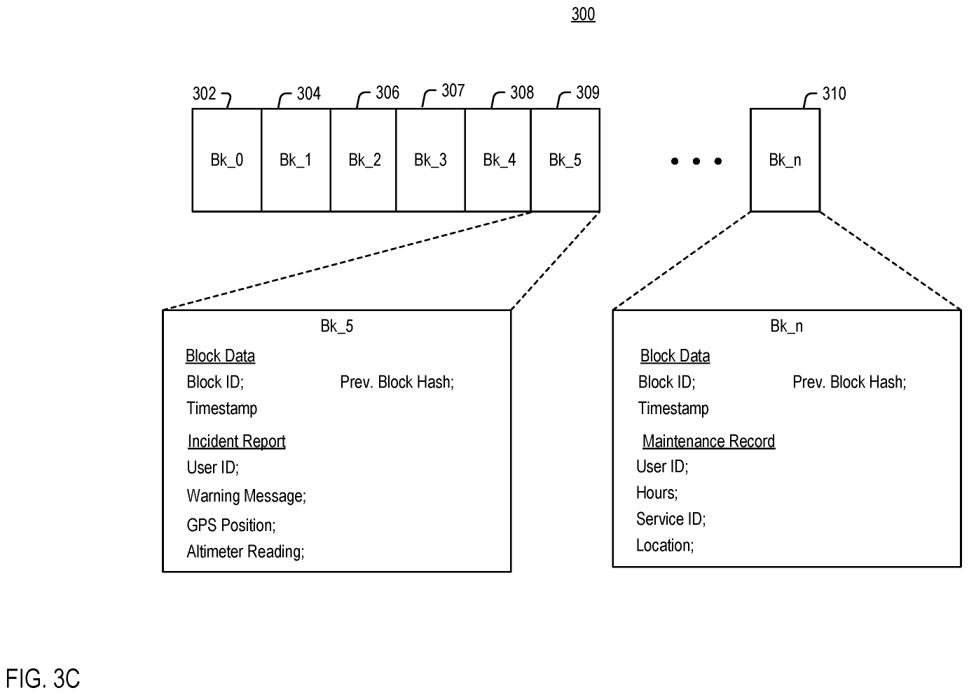

The blockchain data structure 156 may include, among other things, route information associated with the UAV 102, the telemetry data 107, the control instructions 130, and the route instructions 148. For example, the route information 110 may be used to generate blocks of the blockchain data structure 156. A sample blockchain data structure 300 is illustrated in FIGS. 3A-3C. Each block of the blockchain data structure 300 includes block data and other data, such as availability data, route data, telemetry data, service information, incident reports, etc.

The block data of each block includes information that identifies the block (e.g., a block ID) and enables the devices of the system 100 to confirm the integrity of the blockchain data structure 300. For example, the block data also includes a timestamp and a previous block hash. The timestamp indicates a time that the block was created. The block ID may include or correspond to a result of a hash function (e.g., a SHA(256) hash function, a RIPEMD hash function, etc.) based on the other information (e.g., the availability data or the route data) in the block and the previous block hash (e.g., the block ID of the previous block). For example, in FIG. 3A, the blockchain data structure 300 includes an initial block (Bk_0) 302 and several subsequent blocks, including a block Bk_1 304, a block Bk_2 306, a block BK_3 307, a block BK_4 308, a block BK_5 309, and a block Bk_n 310. The initial block Bk_0 302 includes an initial set of availability data or route data, a timestamp, and a hash value (e.g., a block ID) based on the initial set of availability data or route data. As shown in FIG. 1, the block Bk_1 304 also may include a hash value based on the other data of the block Bk_1 304 and the previous hash value from the initial block Bk_0 302. Similarly, the block Bk_2 306 other data and a hash value based on the other data of the block Bk_2 306 and the previous hash value from the block Bk_1 304. The block Bk_n 310 includes other data and a hash value based on the other data of the block Bk_n 310 and the hash value from the immediately prior block (e.g., a block Bk_n−1). This chained arrangement of hash values enables each block to be validated with respect to the entire blockchain; thus, tampering with or modifying values in any block of the blockchain is evident by calculating and verifying the hash value of the final block in the block chain. Accordingly, the blockchain acts as a tamper-evident public ledger of availability data and route data for the system 100.

In addition to the block data, each block of the blockchain data structure 300 includes some information associated with a UAV (e.g., availability data, route information, telemetry data, incident reports, updated route information, maintenance records, UAV software modules in use, etc.). For example, the block Bk_1 304 includes availability data that includes a user ID (e.g., an identifier of the mobile device, or the pilot, that generated the availability data), a zone (e.g., a zone at which the pilot will be available), and an availability time (e.g., a time period the pilot is available at the zone to pilot a UAV). As another example, the block Bk_2 306 includes route information that includes a UAV ID, a start point, an end point, waypoints, GPS coordinates, zone markings, time periods, primary pilot assignments, and backup pilot assignments for each zone associated with the route.

In the example of FIG. 3B, the block BK_3 307 includes telemetry data, such as a user ID (e.g., an identifier of the UAV that generated the telemetry data), a battery level of the UAV; a GPS position of the UAV; and an altimeter reading. As explained in FIG. 1, a UAV may include many types of information within the telemetry data that is transmitted to the blockchain managers of the computers within the distributed computing network 151. In a particular embodiment, the UAV is configured to periodically broadcast to the network 118, a transaction message that includes the UAV's current telemetry data. The blockchain managers of the distributed computing network receive the transaction message containing the telemetry data and store the telemetry data within the blockchain data structure 156.

FIG. 3B also depicts the block BK_4 308 as including updated route information having a start point, an endpoint, and a plurality of zone times and backups, along with a UAV ID. In a particular embodiment, the user device 120 or the server 140 may determine that the route of the UAV should be changed. For example, the control device or the server may detect that the route of the UAV conflicts with a route of another UAV or a developing weather pattern. As another example, the control device or the server many determine that the priority level or concerns of the user have changed and thus the route needs to be changed. In such instances, the control device or the server may transmit to the UAV, updated route information, control data, or navigation information. Transmitting the updated route information, control data, or navigation information to the UAV may include broadcasting a transaction message that includes the updated route information, control data, or navigation information to the network 118. The blockchain manager 155 in the distributed computing network 151, retrieves the transaction message from the network 118 and stores the information within the transaction message in the blockchain data structure 156.

FIG. 3C depicts the block BK_5 309 as including data describing an incident report. In the example of FIG. 3C, the incident report includes a user ID; a warning message; a GPS position; and an altimeter reading. In a particular embodiment, a UAV may transmit a transaction message that includes an incident report in response to the UAV experiencing an incident. For example, if during a flight mission, one of the UAV's propellers failed, a warning message describing the problem may be generated and transmitted as a transaction message.

FIG. 3C also depicts the block BK_n 310 that includes a maintenance record having a user ID of the service provider that serviced the UAV; flight hours that the UAV had flown when the service was performed; the service ID that indicates the type of service that was performed; and the location that the service was performed. UAV must be serviced periodically. When the UAV is serviced, the service provider may broadcast to the blockchain managers in the distributed computing network, a transaction message that includes service information, such as a maintenance record. Blockchain managers may receive the messages that include the maintenance record and store the information in the blockchain data structure. By storing the maintenance record in the blockchain data structure, a digital and immutable record or logbook of the UAV may be created. This type of record or logbook may be particularly useful to a regulatory agency and an owner/operator of the UAV.

Referring back to FIG. 1, in a particular embodiment, the server 140 may include a UAV software module that is configured to receive telemetry information from an airborne UAV and track the UAV's progress and status. The server 140 is also configured to transmit in-flight commands to the UAV 102. Operation of the user device 120 and the server 140 may be carried out by some combination of a human operator and autonomous software (e.g., artificial intelligence (AI) software that is able to perform some or all of the operational functions of a typical human operator pilot).

In a particular embodiment, the route instructions 148 cause the server 140 to plan a flight path, generate route information, dynamically reroute the flight path and update the route information based on data aggregated from a plurality of data servers. For example, the server 140 may receive air traffic data 167 over the network 119 from the air traffic data server 160, weather data 177 from the weather data server 170, regulatory data 187 from the regulatory data server 180, and topographical data 197 from the topographic data server 190. It will be recognized by those of skill in the art that other data servers useful in-flight path planning of a UAV may also provide data to the server 140 over the network 118 or through direct communication with the server 140. Additionally, communication with each data server may be enabled through the use of a UAV software module as described herein.

The air traffic data server 160 may include a processor 162, memory 164, and communication circuitry 168. The memory 164 of the air traffic data server 160 may include operating instructions 166 that when executed by the processor 162 cause the processor to provide the air traffic data 167 about the flight paths of other aircraft in a region, including those of other UAVs. The air traffic data may also include real-time radar data indicating the positions of other aircraft, including other UAVs, in the immediate vicinity or in the flight path of a particular UAV. Air traffic data servers may be, for example, radar stations, airport air traffic control systems, the FAA, UAV control systems, and so on.

The weather data server 170 may include a processor 172, memory 174, and communication circuitry 178. The memory 174 of the weather data server 170 may include operating instructions 176 that when executed by the processor 172 cause the processor to provide the weather data 177 that indicates information about atmospheric conditions along the UAV's flight path, such as temperature, wind, precipitation, lightening, humidity, atmospheric pressure, and so on. Weather data servers may be, for example, the National Weather Service (NWS), the National Oceanic and Atmospheric Administration (NOAA), local meteorologists, radar stations, other aircraft, and so on.

The regulatory data server 180 may include a processor 182, memory 184, and communication circuitry 188. The memory 184 of the weather data server 170 may include operating instructions 186 that when executed by the processor 182 cause the processor to provide the regulatory data 187 that indicates information about laws and regulations governing a particular region of airspace, such as airspace restrictions, municipal and state laws and regulations, permanent and temporary no-fly zones, and so on. Regulatory data servers may include, for example, the FAA, state and local governments, the Department of Defense, and so on.

The topographic data server 190 may include a processor 192, memory 194, and communication circuitry 198. The memory 194 of the topographic data server 190 may include operating instructions 196 that when executed by the processor 192 cause the processor to provide the topographical data that indicates information about terrain, places, structures, transportation, boundaries, hydrography, ortho-imagery, land cover, elevation, and so on. Topographic data may be embodied in, for example, digital elevation model data, digital line graphs, and digital raster graphics. Topographic data servers may include, for example, the United States Geological Survey or other geographic information systems (GISs).

In some embodiments, the server 140 may aggregate data from the data servers 160, 170, 180, 190 using application program interfaces (APIs), syndicated feeds and eXtensible Markup Language (XML), natural language processing, JavaScript Object Notation (JSON) servers, or combinations thereof. Updated data may be pushed to the server 140 or may be pulled on-demand by the server 140. Notably, the FAA may be an important data server for both airspace data concerning flight paths and congestion as well as an important data server for regulatory data such as permanent and temporary airspace restrictions. For example, the FAA provides the Aeronautical Data Delivery Service (ADDS), the Aeronautical Product Release API (APRA), System Wide Information Management (SWIM), Special Use Airspace information, and Temporary Flight Restrictions (TFR) information, among other data. The National Weather Service (NWS) API allows access to forecasts, alerts, and observations, along with other weather data. The USGS Seamless Server provides geospatial data layers regarding places, structures, transportation, boundaries, hydrography, ortho-imagery, land cover, and elevation. Readers of skill in the art will appreciate that various governmental and non-governmental entities may act as data servers and provide access to that data using APIs, JSON, XML, and other data formats.

Readers of skill in the art will realize that the server 140 can communicate with a UAV 102 using a variety of methods. For example, the UAV 102 may transmit and receive data using Cellular, 5G, Sub1 GHz, SigFox, WiFi networks, or any other communication means that would occur to one of skill in the art.

The network 119 may comprise one or more Local Area Networks (LANs), Wide Area Networks (WANs), cellular networks, satellite networks, internets, intranets, or other networks and combinations thereof. The network 119 may comprise one or more wired connections, wireless connections, or combinations thereof.

The arrangement of servers and other devices making up the exemplary system illustrated in FIG. 1 are for explanation, not for limitation. Data processing systems useful according to various embodiments of the present disclosure may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), and others as will occur to those of skill in the art. Various embodiments of the present invention may be implemented on a variety of hardware platforms in addition to those illustrated in FIG. 1.

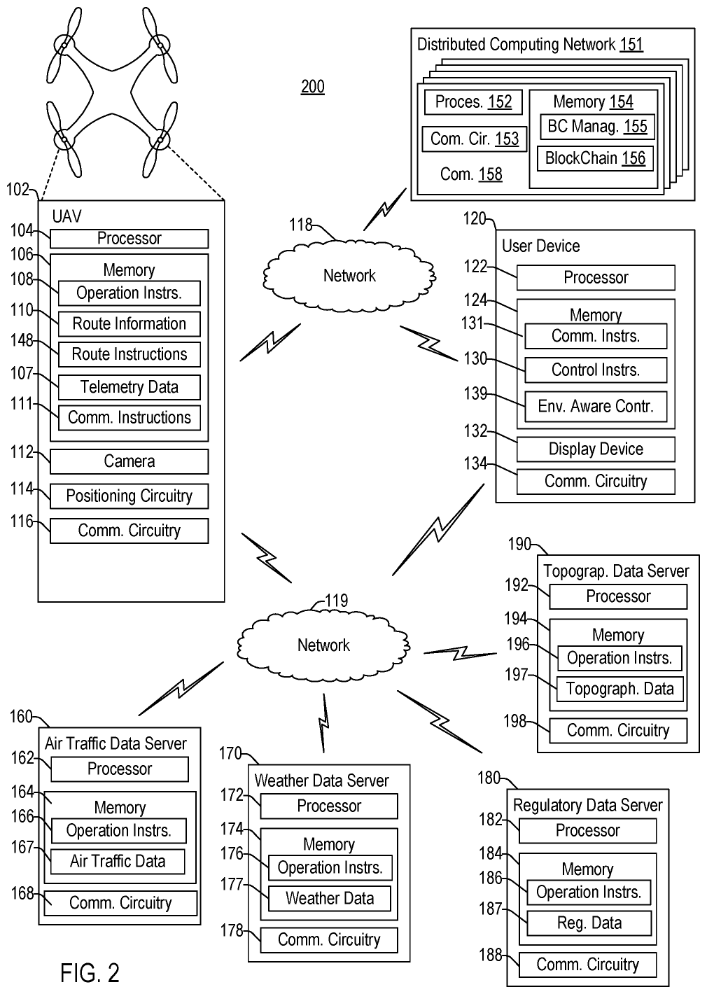

For further explanation, FIG. 2 sets forth a block diagram illustrating another implementation of a system 200 of increasing awareness of an environmental condition for an unmanned aerial vehicle (UAV). Specifically, the system 200 of FIG. 2 shows an alternative configuration in which one or both of the UAV 102 and the server 140 may include route instructions 148 for generating route information. In this example, instead of relying on a server 140 to generate the route information, the UAV 102 and the user device 120 may retrieve and aggregate the information from the various data sources (e.g., the air traffic data server 160, the weather data server 170, the regulatory data server 180, and the topographical data server 190). As explained in FIG. 1, the route instructions may be configured to use the aggregated information from the various source to plan and select a flight path for the UAV 102.

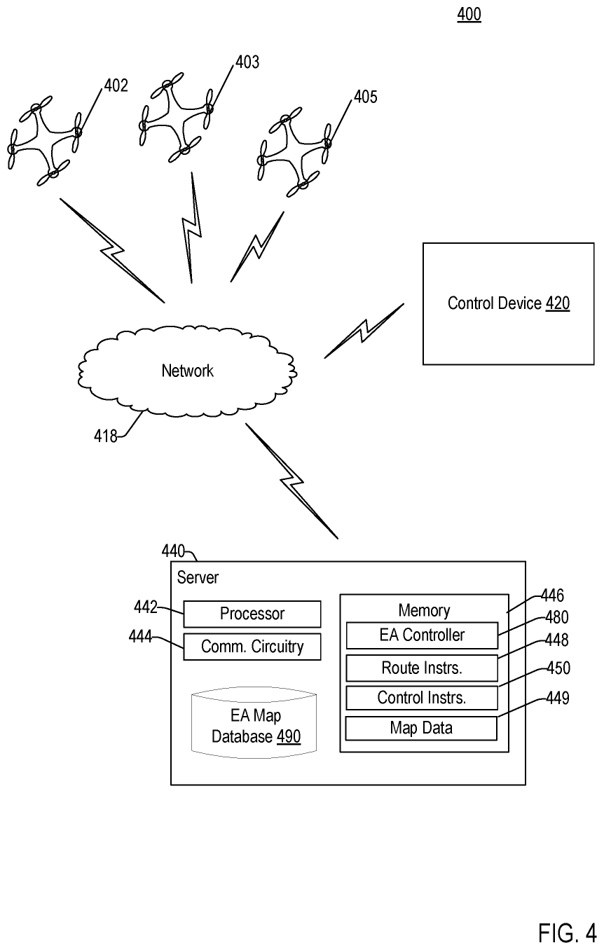

For further explanation, FIG. 4 sets forth a block diagram illustrating a particular implementation of a system 400 for updating airspace awareness for unmanned aerial vehicles according to some embodiments of the present disclosure. The system 400 includes the first UAV 402, a second UAV 403, a third UAV 405, which may be similarly configured to the UAV 102 of FIG. 1 and FIG. 2. The system 400 also includes a control device 420 may be similarly configured to the user device 120 of FIG. 1 and FIG. 2. The system 400 also includes a map server 440 that may be implemented by the server 140 of FIG. 1 or by another computing device communicating with the UAVs 402, 403, 405 and/or the control device 420. When the map server 440 is another computing device not depicted in FIG. 1 or FIG. 2, the map server may also include a processor 442 coupled to communication circuitry 444 and a memory 446. The memory 446 may include operating instructions 448 that are configured to transmit map data 449 via the communication circuitry 444 to the UAVs 402, 403, 405 and/or the control device 420. In some examples, the map data 449 includes data related to an environmental awareness map. The memory may also include control instructions 450 that include instructions or code that cause the server 440 to generate control data to transmit to one or more UAVs 402, 403, 405 to enable the server 440 to control one or more operations of the UAV during a particular time period. The memory 446 may also include an environmental awareness controller 480 implemented by computer executable instructions that cause processor 442 to carry out the operations: utilizing data associated with a first UAV to detect an environmental condition at a location associated with the first UAV; updating environmental condition information associated with the location to indicate detection of the environmental condition at the location; and providing the updated environmental condition information to a second UAV. In another embodiment, the environmental awareness controller includes computer program instructions that when executed by the processor 442 cause the processor 442 to carry out the operations of receiving from a device associated with a first UAV, a request for environmental condition information for a location; retrieving the environmental condition information from a repository of environmental condition information that indicates environmental conditions detected based on data associated with one or more other UAVs; and providing the environmental condition information to the device associated with the first UAV.

The map server 440 maintains an environmental awareness map database 490. In some examples, the environmental awareness map database 490 includes indications of particular locations that should be avoided by a UAV because they are locations where UAV flight would, for example, pose a risk to the UAV. While in some examples the map database 490 identifies the location with a tag indicating the location that should be avoided in a UAV flight path, in other examples the map database 490 may also include a tag of an environmental condition at the location that is to be avoided. For example, the tag may include the type of environmental condition or other details about the environmental condition.

In some implementations, the map server 440 acts as a central repository for the environmental awareness map database 490 and modifications to it. In these implementations, the server 440 provides environmental awareness map data 449 to the UAVs 402, 403, 405 and the control device 420 for route planning, navigation, and UAV missions. Accordingly, the memory the UAVs 402, 403, 405 or the memory of the control device 420 may include a local copy of an environmental awareness map generated from airspace awareness map data 449. The UAVs 402, 403, 405 or the control device 420 may load an environmental awareness map relevant to the intended flight path of the UAV from the map server 440 during prior to initiating a mission. The UAVs 402, 403, 405 or the control device 420 may also load an environmental awareness map relevant to the current flight path of the UAV from the map server 440 on-demand while the UAV is in flight. In addition to route planning and navigation, the UAVs 402, 403, 405 and the control device 420 may load an environmental awareness map from the map sever 440 that includes tags and locations of environmental conditions that are relevant to the UAV's mission. The UAVs 402, 403, 405 or the control device 420 may also generate updates to the environmental awareness map database 490 that are provided to the map server 440 based on in-flight observations, and the server 440 may propagate updates received from one UAV to other UAVs.

In a particular embodiment, the UAVs 402, 403, 405, the map server 440, the control device 420 are coupled for communication to a network 418. The network 418 may include a cellular network, a satellite network or another type of network that enables wireless communication between the UAVs 402, 403, 405, the server 440, the control device 420. In an alternative implementation, the UAVs 402, 403, 405, the server 440, the control device 420 communicate with each other via separate networks (e.g., separate short range networks). While only one control device 420 is illustrated, it will be appreciated that each UAV 402, 403, 405 may be operated by a distinct control device or the same control device.

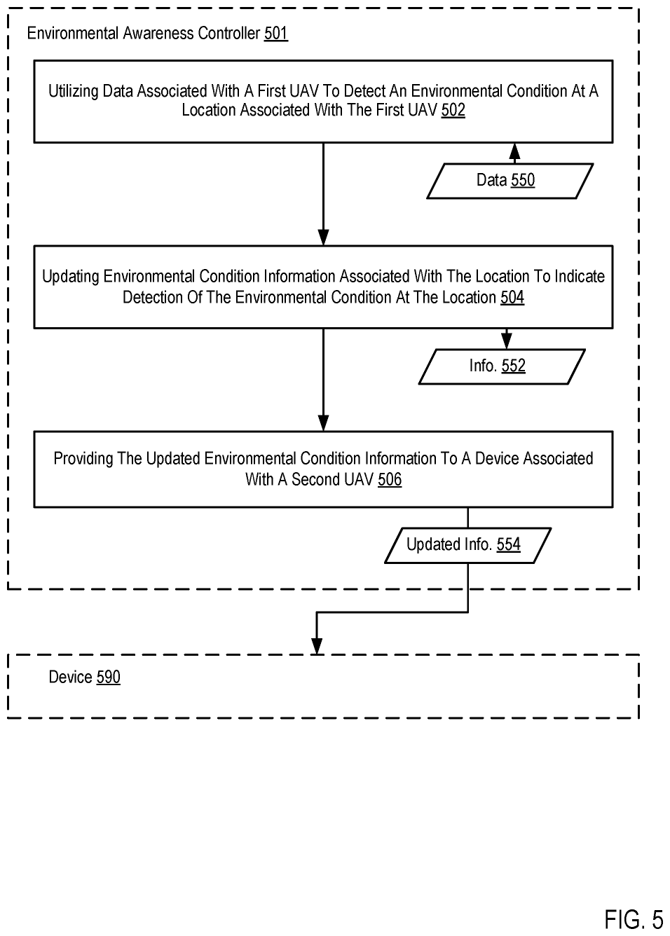

For further explanation, FIG. 5 sets forth a flow chart illustrating an exemplary method of increasing awareness of an environmental condition for an unmanned aerial vehicle (UAV) in accordance with at least one embodiment of the present disclosure. An environmental awareness controller 501 may include a set of computer program instructions that are executed by a processor. For example, the environmental awareness controller 501 of FIG. 5 may be the environmental awareness controller 139 of FIGS. 1 and 2 or the environmental awareness controller 145 of FIG. 1. The method of FIG. 5 includes utilizing 502, by the environmental awareness controller 501, data 550 associated with a first UAV to detect an environmental condition at a location associated with the first UAV. In a particular embodiment, the data 550 associated with a first UAV may be based on sensor data generated by the first UAV or based on sensor data generated by one or more other UAVs.

A UAV may be equipped with any number of sensors that are configured to each capture data regarding the location or environmental condition of the area in proximity to the UAV. Examples of sensors that may be equipped on a UAV include by are not limited to: gyroscopes; accelerometers; thermometers; inertial measurement sensors (magnetometer); barometers; GPS sensors; distance sensors (e.g., sensors based on radio detection and ranging; magnetic-field change sensing; sonar-pulse distance sensing (ultrasonic); time of flight (ToF) sensors (range imaging); light-pulse distance sensing (laser); SONAR, RADAR, and LIDAR); cameras; anemometers to measure wind speed and direction; heat detection devices (e.g., infrared sensors, thermal imaging vision cameras, etc.); and chemical sensors for the detection of chemicals present in the environment.

An environmental condition is an indication of a condition of the environment. An environment condition may include detections, measurements, and indications of conditions, occurrences, events, actions, and operations that are external to the one or more components of the UAV and may impact the operation of the UAV. Examples of environmental conditions include but are not limited to measurements, detections, or indications of weather conditions (e.g., measurements of pressure, wind speed, wind direction; detection and measurement of precipitation and moisture; detection of fog; detection of lightning strike); electromagnetic interferences, disruptions, or miscommunication (e.g., topography blocking signal; signal-jamming devices); detections of gases and chemicals; and detected disruptions to expected behavior of UAVs.

In a particular embodiment, utilizing 502, by the environmental awareness controller 501, data associated with a first UAV to detect an environmental condition at a location associated with the first UAV may be carried out by the environmental awareness controller 501 collecting the data from one or more sensors of a UAV; utilizing sensor data from other instruments, sensors, devices, other UAVs, and data content servers (e.g., weather data server 170 of FIG. 1; topographical data server 190 of FIG. 1); generating one or more values to indicate, represent, and identify the environment condition (e.g., a wind speed value; a wind direction value; lightning strike value; chemical detected value); associating the measurements with a location (e.g., fog detected at this location; chemical gas detected at this location; precipitation detected at this location); and applying data analytics to identify, predict, and estimate the scope, size, extent, duration, other parameters associated with the environmental condition and additional environmental conditions.

The method of FIG. 5 also includes updating 504, by the environmental awareness controller 501, environmental condition information 552 associated with the location to indicate detection of the environmental condition at the location. Environmental condition information is information that indicates information about an environmental condition at a particular location. In a particular embodiment, the environmental condition information is a data structure that indicates locations and for every location, any associated detected, indicated, or measured environmental conditions at the location. In some examples, the environmental condition information includes the location where the environmental condition was measured, detected, or identified and a tag associated with the location. For example, the tag may designate that the location is an area to avoid based on the type or identification of the environmental condition. In other examples, the tag may designate a level or rating for the environmental condition. The tag may also specify a requirement or recommendation of the type of hardware, software, or components of a UAV to fly through the location experiencing the environmental condition. As another example, the tag may specify a minimum level or rating of a UAV that is recommended for traveling through the location associated with the environmental condition.

Updating 504, by the environmental awareness controller 501, environmental condition information associated with the location to indicate detection of the environmental condition at the location may be carried out by determining whether the environmental condition information already includes data indicating the environmental condition; determining that the environmental condition information does not include the data indicating the environmental condition; and adding, changing, rewriting, overwriting or otherwise updating the environmental information to include the data indicating the environmental condition.

In addition, the method of FIG. 5 also includes providing 506, by the environmental awareness controller 501, the updated environmental condition information 554 to a device 590 (e.g., a UAV; a user device; a control device, a server; a distributed computing network) associated with second UAV. Providing 506, by the environmental awareness controller 501, the updated environmental condition information to a device associated with second UAV may be carried out by transmitting an update to one or more UAV system components such as a UAV, a UAV control device, a UAV user device, a distributed computing network, a server, or a user device coupled to the UAV system (e.g., the UAV system 100 of FIG. 1). For example, the update may be transmitted in a transaction message. In some examples, providing 506, by the environmental awareness controller 501, the updated environmental condition information to a device associated with second UAV includes generating an alert containing an update to a UAV operator or other user, for example, via a device's user interface.

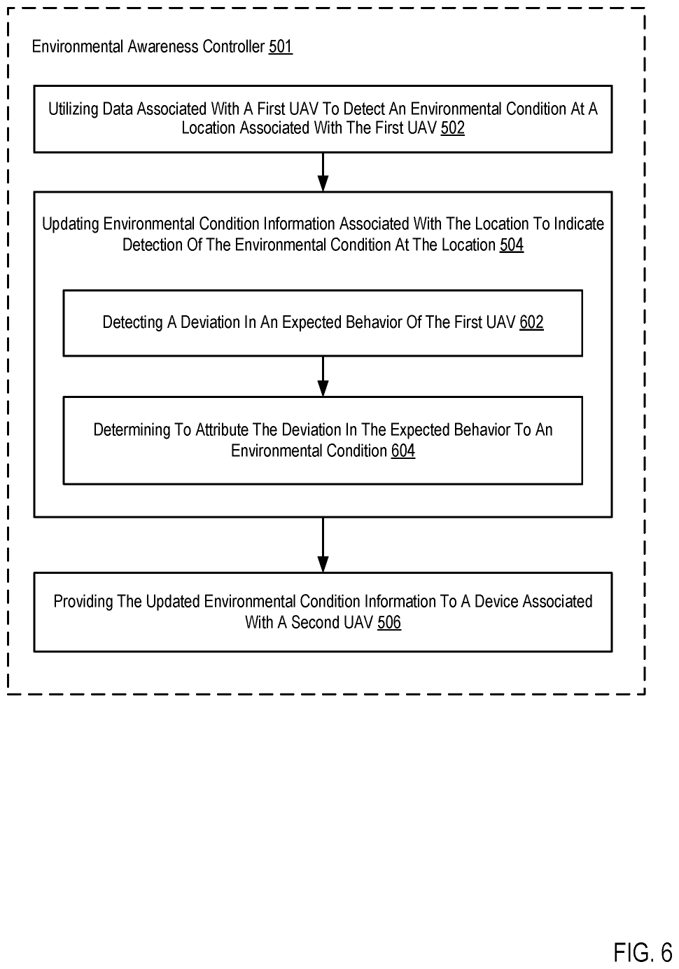

For further explanation, FIG. 6 sets forth a flow chart illustrating an exemplary method of increasing awareness of an environmental condition for an unmanned aerial vehicle (UAV) in accordance with at least one embodiment of the present disclosure. The method of FIG. 6 is similar to the method of FIG. 5 in that the method of FIG. 6 also includes utilizing 502, by the environmental awareness controller 501, data associated with a first UAV to detect an environmental condition at a location associated with the first UAV; updating 504, by the environmental awareness controller 501, environmental condition information associated with the location to indicate detection of the environmental condition at the location; and providing 506, by the environmental awareness controller 501, the updated environmental condition information to a device associated with second UAV.

In the method of FIG. 6, utilizing 502, by the environmental awareness controller 501, data associated with a first UAV to detect an environmental condition at a location associated with the first UAV includes detecting 602 a deviation in an expected behavior of the first UAV.

A UAV may be configured to perform operations or may receive instructions or commands to perform operations. The result of the UAV performing those operations in accordance with the instructions, commands, or configuration is the expected behavior of the UAV. That is, the expected behavior of the UAV is the result of the UAV correctly performing operations in accordance with a command, instruction, or configuration. Examples of operations and the associated expected behavior include but are not limited to instructing the UAV to change directions (e.g., instructing the UAV to change the speed and angle of propellers) and the UAV changing directions; instructing the UAV to open or close payload doors and the UAV opening or closing the payload doors; instructing the UAV to lower hooks or landing gear and the UAV lowering the hooks or landing gear; instructing the UAV to turn navigation or running lights on/off and the navigation or running lights turning on/off; instructing the UAV to operate software and hardware components and sensors, such as cameras, GPS receivers, wireless transceivers, infrared scanners, and others as will occur to those of skill in the art, and the software and hardware components and sensors operating properly.

For example, a UAV may receive from a user device, a command to turn right. In this example, if the UAV performs the command, the expected behavior of the UAV is that the flight path of the UAV would turn right. Continuing with this example, after receiving the command to turn right, if the flight path of the UAV does not turn right and instead the UAV exhibits other behavior (e.g., the flight path continues straight; turns up, left, or down; or does not turn right to the degree expected), this other behavior represents a deviation in the expected behavior of the UAV. That is, a deviation in the expected behavior of the UAV is a behavior outcome that is different than the expected behavior outcome of the UAV executing or performing an operation or action in accordance with the instructions, commands, or configuration of the UAV.

As explained above, the expected behavior of the UAV may also include the correct operation of the hardware and software components of the UAV. For example, a UAV may be configured to perform the operation of turning on a GPS receiver to receive a GPS signal. In this example, if the UAV performs the operation, the expected behavior of the UAV is that the UAV receives a GPS signal at the receiver. Continuing with this example, if the UAV does not receive a GPS signal, the behavior outcome of ‘not receiving a signal’ is a deviation in the expected behavior of the UAV.

The environmental awareness controller may detect a deviation in an expected behavior of a UAV by receiving feedback or data from the UAV that indicates the deviation. For example, the UAV may provide to the environmental awareness controller, location information (e.g., GPS data, tracking data, coordinates, etc.) that indicates the UAV has turned to the right instead of the expected behavior of turning left. In another example, the UAV may provide to the environmental awareness controller an error message indicating that the payload door is open instead of the expected behavior of being closed. As another example, the UAV may provide to the environmental awareness controller a message or data indicating that the GPS receiver is not receiving a GPS signal.

Alternatively, the environmental awareness controller may also detect the deviation by receiving feedback or data from other UAVs, servers, devices, or sensors that may provide evidence or examples of the deviation. For example, a radar system may show the UAV turning right instead of the expected behavior of turning left. In another example, another UAV may provide a camera feed that shows the UAV with navigation lights turned off instead of the expected behavior of having the navigation lights turned on.

In the method of FIG. 6, utilizing 502, by the environmental awareness controller 501, data associated with a first UAV to detect an environmental condition at a location associated with the first UAV includes determining 604 to attribute the deviation in the expected behavior to an environmental condition. A deviation in the expected behavior is generally the result of some combination of a malfunction with one or more components of the UAV and one or more environmental conditions that affect the behavior of the UAV.

For example, in response to receiving a command to turn left, the UAV may adjust the speed and angle of the propellers according to a predefined set of instructions that are designed to make the UAV turn left. Continuing with this example, the environmental awareness controller may detect that the UAV turned right instead of turning left. As explained above, any number of issues may have occurred that resulted in the UAV experiencing the deviation (i.e., turning right) from the expected behavior of turning left. For example, the UAV may have experienced a mechanical issue, such as a propeller engine malfunction or actuator failure, which caused the UAV to turn right. Another reason for the deviation might be the UAV wireless receiver experienced a malfunction that caused the receiver of the UAV to fail to receive from the user device, the instruction to turn. Still another reason for the deviation might be an environmental condition, such as a wind gust causing the UAV to turn right despite the UAV properly changing the speed and angle of the propellers to execute a change in direction to the left.

According to embodiments, the environmental awareness controller may use information and data from the UAV and other sources to determine whether to attribute the deviation to any environmental conditions. Determining 604 to attribute the deviation in the expected behavior to an environmental condition may be carried out by retrieving information and data from the UAV; retrieving information and data from sources external to the UAV; and using the retrieved information and data to determine whether to attribute the deviation to any environmental conditions.

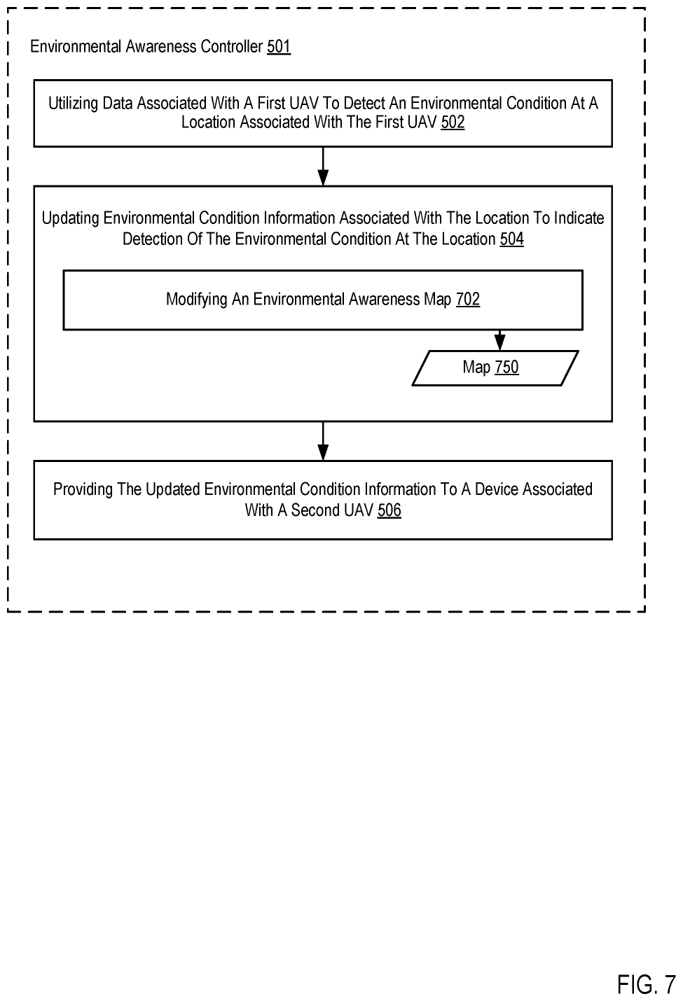

For further explanation, FIG. 7 sets forth a flow chart illustrating an exemplary method of increasing awareness of an environmental condition for an unmanned aerial vehicle (UAV) in accordance with at least one embodiment of the present disclosure. The method of FIG. 7 is similar to the method of FIG. 5 in that the method of FIG. 7 also includes utilizing 502, by the environmental awareness controller 501, data associated with a first UAV to detect an environmental condition at a location associated with the first UAV; updating 504, by the environmental awareness controller 501, environmental condition information associated with the location to indicate detection of the environmental condition at the location; and providing 506, by the environmental awareness controller 501, the updated environmental condition information to a device associated with second UAV.

In the method of FIG. 7, utilizing 502, by the environmental awareness controller 501, data associated with a first UAV to detect an environmental condition at a location associated with the first UAV includes modifying 702 an environmental awareness map 750. In some examples, one or more components of a UAV system (e.g., the system 100 of FIG. 1), such as a UAV, a control device, a server, a distributed computing network, or other components, includes an environmental awareness map (e.g., the environmental awareness map database 490 of FIG. 4), while in other examples an external environmental awareness map database may be coupled to one or more components of the UAV system. The environmental awareness map database includes, for example, a database of environmental condition tags indexed by location. An environmental awareness map may be generated from the environmental awareness map database by correlating the locations associated with the tags to locations on a navigational map and overlaying the tags on the navigational map. A modification to the environmental awareness map may add an entry to the environmental awareness map that includes a location and a tag (e.g., a classification, a rating, a magnitude of a value, or other parameters useful for describing the environmental condition and the implications for a UAV flying in proximity). In some implementations, an update or modification to the environmental awareness map is made in the form of an API call to a map server that maintains the environmental awareness map database, where the API call includes the location and tag for the environmental condition to be added.

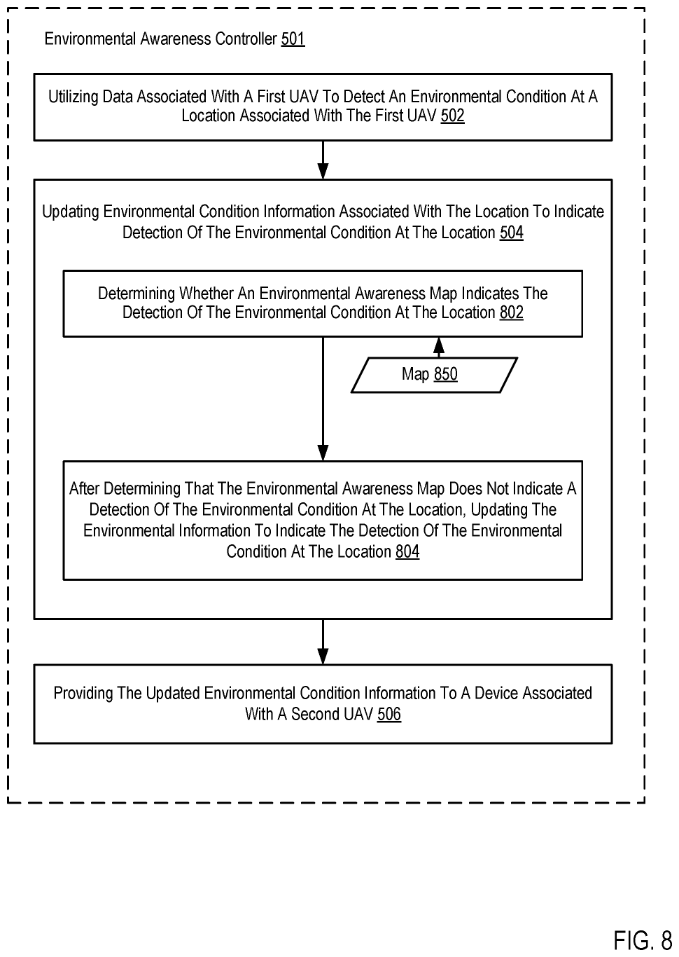

For further explanation, FIG. 8 sets forth a flow chart illustrating an exemplary method of increasing awareness of an environmental condition for an unmanned aerial vehicle (UAV) in accordance with at least one embodiment of the present disclosure. The method of FIG. 8 is similar to the method of FIG. 5 in that the method of FIG. 8 also includes utilizing 502, by the environmental awareness controller 501, data associated with a first UAV to detect an environmental condition at a location associated with the first UAV; updating 504, by the environmental awareness controller 501, environmental condition information associated with the location to indicate detection of the environmental condition at the location; and providing 506, by the environmental awareness controller 501, the updated environmental condition information to a device associated with second UAV.

In the method of FIG. 8, utilizing 502, by the environmental awareness controller 501, data associated with a first UAV to detect an environmental condition at a location associated with the first UAV includes determining 802 whether an environmental awareness map 850 indicates the detection of the environmental condition at the location. Determining 802 whether an environmental awareness map indicates the detection of the environmental condition at the location may be carried out by looking up the identified location of the environmental condition in an environmental awareness map database (e.g., the environmental awareness map database 490 of FIG. 4) to determine whether an entry for the location includes a tag for an environmental condition that matches the detected environmental condition. For example, for a particular location, if a classification of the detected environmental condition matches a condition classification in a tag in the environmental awareness map database, it may be determined that the environmental awareness map includes the environmental condition. However, if the classification of the detected environmental condition does not match a condition classification in a tag in the environmental awareness map database for the particular location, or if there is no entry in the environmental awareness map data base that includes the particular location, it may be determined that the environmental awareness map does not include the environmental condition.

In the method of FIG. 8, utilizing 502, by the environmental awareness controller 501, data associated with a first UAV to detect an environmental condition at a location associated with the first UAV includes after determining that the environmental awareness map does not indicate a detection of the environmental condition at the location, updating 804 the environmental information to indicate the detection of the environmental condition at the location. Updating 804 the environmental information to indicate the detection of the environmental condition at the location may be carried out by determining, for a particular location, that the information does not match classification or value in a tag in the map database, or that there is no tag for the particular location and generating the environmental awareness update. Updating the environmental awareness map with redundant information may be avoided by only generating the environmental awareness update in response to determining that the environmental awareness map omits information about the environmental condition, thereby minimizing communication and conserving system resources. For example, the environmental awareness map database may include a tag indicating a precipitation value of 1 (e.g., indicating no or little rain) for location X. In this example, the environmental awareness controller may update the precipitation value to 10 after receiving sensor data that indicates a UAV is flying through rain at location X.

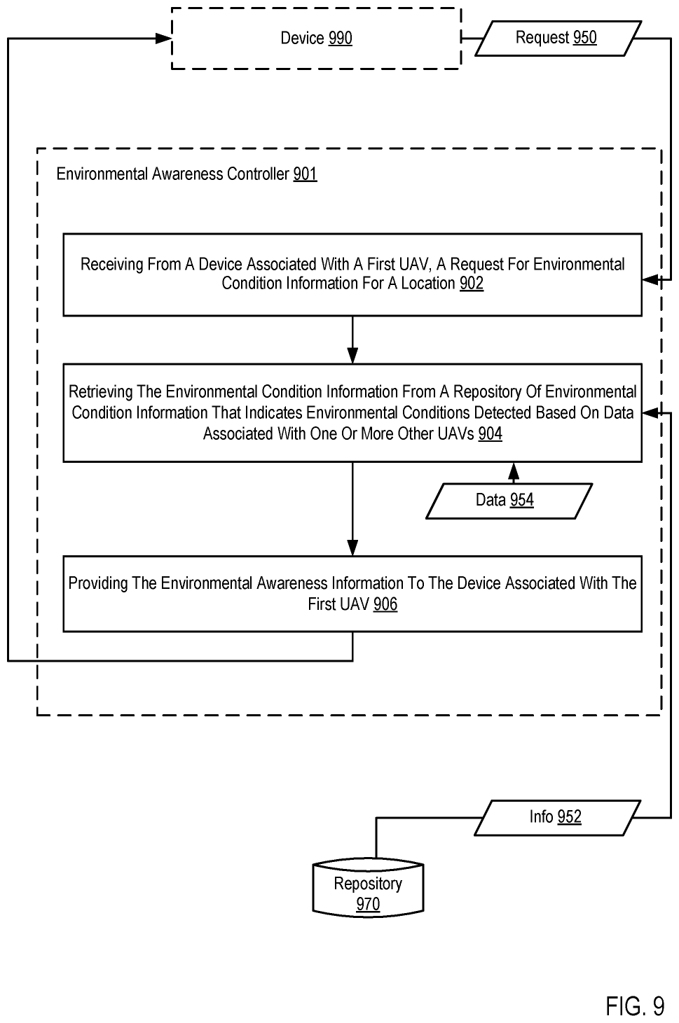

For further explanation, FIG. 9 sets forth a flow chart illustrating an exemplary method of increasing awareness of an environmental condition for an unmanned aerial vehicle (UAV) in accordance with at least one embodiment of the present disclosure. An environmental awareness controller 901 may include a set of computer program instructions that are executed by a processor. For example, the environmental awareness controller 901 of FIG. 9 may be the environmental awareness controller 139 of FIGS. 1 and 2 or the environmental awareness controller 145 of FIG. 1. The method of FIG. 9 includes receiving 902 from a device 990 (e.g., a UAV; a user device; a control device, a server; a distributed computing network) associated with a first UAV, by an environmental awareness controller 901, a request 950 for environmental condition information for a location. Receiving 902 from the device associated with the first UAV, by an environmental awareness controller 901, a request for environmental condition information for a location may be carried out by receiving a transaction message, an API call, a database query, a message, an email, or other form of communication from a UAV, a control device, a server, a distributed computing network.

The method of FIG. 9 also includes retrieving 904, by the environmental awareness controller 901, the environmental condition information from a repository 970 of environmental condition information that indicates environmental conditions detected based on data 954 associated with one or more other UAVs. A repository of environmental condition information may include data structures, databases (e.g., the environmental awareness map database 490 of FIG. 4), storage locations, servers. Retrieving 904, by the environmental awareness controller 901, the environmental condition information from a repository of environmental condition information that indicates environmental conditions detected based on data associated with one or more other UAVs may be carried out by querying a database with a location; and receiving the environmental condition information associated with the location.

In addition, the method of FIG. 9 also includes providing 906, by the environmental awareness controller 901, the environmental condition information 952 to the device 990 associated with the first UAV. Providing 906, by the environmental awareness controller 901, the environmental condition information to a device associated with the first UAV may be carried out by transmitting an update to the UAV; transmitting an update to one or more UAV system components such as a UAV control device, a distributed computing network, a server, or a user device coupled to the UAV system (e.g., the UAV system 100 of FIG. 1), which in turn provide an update to the UAV. For example, the update may be transmitted in a transaction message. In some examples, providing 906 the updated environmental condition information includes generating an alert containing an update to a UAV operator or other user, for example, via a device's user interface.

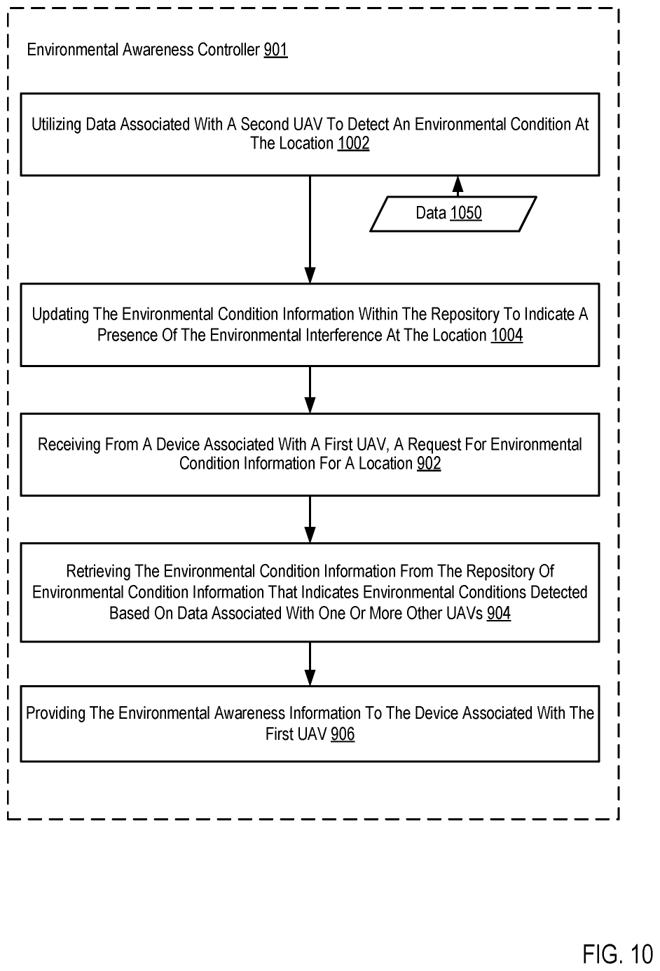

For further explanation, FIG. 10 sets forth a flow chart illustrating an exemplary method of increasing awareness of an environmental condition for an unmanned aerial vehicle (UAV) in accordance with at least one embodiment of the present disclosure. The method of FIG. 10 is similar to the method of FIG. 9 in that the method of FIG. 10 also includes receiving 902 from a device associated with a first UAV, by an environmental awareness controller 901, a request for environmental condition information for a location; retrieving 904, by the environmental awareness controller 901, the environmental condition information from a repository of environmental condition information that indicates environmental conditions detected based on data associated with one or more other UAVs; and providing 906, by the environmental awareness controller 901, the environmental condition information to the device associated with the first UAV.

However, the method of FIG. 10 also includes utilizing 1002, by the environmental awareness controller 901, data 1050 associated with a second UAV to detect an environmental condition at the location. Utilizing 1002, by the environmental awareness controller 901, data associated with a second UAV to detect an environmental condition at the location may be carried out by collecting the data from one or more sensors of a UAV; utilize sensor data from other instruments, sensors, devices, other UAVs, and data content servers (e.g., weather data server 170 of FIG. 1; topographical data server 190 of FIG. 1); generating one or more values to indicate, represent, and identify the environment condition (e.g., a wind speed value; a wind direction value; lightning strike value; chemical detected value); associating the measurements with a location (e.g., fog detected at this location; chemical gas detected at this location; precipitation detected at this location); and apply data analytics to identify, predict, and estimate the scope, size, extent, duration, other parameters associated with the environmental condition and additional environmental conditions.

The method of FIG. 10 also includes updating 1004, by the environmental awareness controller 901, the environmental condition information within the repository 970 to indicate a presence of the environmental condition at the location. Updating 1004, by the environmental awareness controller 901, the environmental condition information to indicate a presence of the environmental condition at the location may be carried out by determining whether the environmental condition information already includes data indicating the environmental condition; determining that the environmental condition information does not include the data indicating the environmental condition; and adding, changing, rewriting, overwriting or otherwise updating the environmental information to include the data indicating the environmental condition.

Exemplary embodiments of the present invention are described largely in the context of a fully functional computer system for managing UAV software modules. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Hardware logic, including programmable logic for use with a programmable logic device (PLD) implementing all or part of the functionality previously described herein, may be designed using traditional manual methods or may be designed, captured, simulated, or documented electronically using various tools, such as Computer Aided Design (CAD) programs, a hardware description language (e.g., VHDL or Verilog), or a PLD programming language. Hardware logic may also be generated by a non-transitory computer readable medium storing instructions that, when executed by a processor, manage parameters of a semiconductor component, a cell, a library of components, or a library of cells in electronic design automation (EDA) software to generate a manufacturable design for an integrated circuit. In implementation, the various components described herein might be implemented as discrete components or the functions and features described can be shared in part or in total among one or more components. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Advantages and features of the present disclosure can be further described by the following statements:

1. A method for increasing awareness of an environmental condition for an unmanned aerial vehicle (UAV), the method comprising: utilizing, by an environmental awareness controller, data associated with a first UAV to detect an environmental condition at a location associated with the first UAV; updating, by the environmental awareness controller, environmental condition information associated with the location to indicate detection of the environmental condition at the location; and providing, by the environmental awareness controller, the updated environmental condition information to a device associated with a second UAV.

2. The method of statement 1, wherein the data associated with the first UAV is based on sensor data generated by the first UAV.

3. The method of any of the statements 1-2, wherein the data associated with the first UAV is based on sensor data generated by one or more other UAVs.

4. The method of any of the statements 1-3, wherein utilizing, by an environmental awareness controller, data associated with a first UAV to detect an environmental condition at a location associated with the first UAV includes: detecting a deviation in an expected behavior of the first UAV; and determining to attribute the deviation in the expected behavior to an environmental condition.

5. The method of any of the statements 1-4 wherein updating, by the environmental awareness controller, environmental condition information associated with the location to indicate a detection of the environmental condition at the location includes modifying an environmental awareness map.

6. The method of any of the statements 1-5 wherein updating, by the environmental awareness controller, environmental condition information associated with the location to indicate a detection of the environmental condition at the location includes determining whether an environmental awareness map indicates the detection of the environmental condition at the location; and after determining that the environmental awareness map does not indicate a detection of the environmental condition at the location, updating the environmental information to indicate the detection of the environmental condition at the location.

7. A method of increasing awareness of environmental conditions for an unmanned aerial vehicle (UAV), the method of none or any of the statements 1-6 and the method comprising: receiving from a device associated with a first UAV, by an environmental awareness controller, a request for environmental condition information for a location; retrieving, by the environmental awareness controller, the environmental condition information from a repository of environmental condition information that indicates environmental conditions detected based on data associated with one or more other UAVs; and providing, by the environmental awareness controller, the environmental condition information to the device associated with the first UAV.

8. The method of any of the statements 1-7 further comprising: utilizing, by the environmental awareness controller, data associated with a second UAV to detect an environmental condition at the location; and updating, by the environmental awareness controller, the environmental condition information within the repository to indicate a presence of the environmental condition at the location.

9. The method of any of the statements 1-8, wherein the data associated with the second UAV is based on sensor data generated by the first UAV.

10. The method of any of the statements 1-9, wherein the data associated with the second UAV is based on sensor data generated by one or more other UAVs.

11. An apparatus for increasing awareness of environmental conditions for an unmanned aerial vehicle (UAV), the apparatus comprising: a processor; and a non-transitory computer readable medium storing instructions that when executed by the processor, cause the apparatus to carry out operations including: utilizing, by an environmental awareness controller, data associated with a first UAV to detect an environmental condition at a location associated with the first UAV; updating, by the environmental awareness controller, environmental condition information associated with the location to indicate detection of the environmental condition at the location; and providing, by the environmental awareness controller, the updated environmental condition information to device associated with a second UAV.

12. The apparatus of statement 11, wherein the data associated with the first UAV is based on sensor data generated by the first UAV.

13. The apparatus of any of the statements 11-12, wherein the data associated with the first UAV is based on sensor data generated by one or more other UAVs.

14. The apparatus of any of the statements 11-13, wherein utilizing, by an environmental awareness controller, data associated with a first UAV to detect an environmental condition at a location associated with the first UAV includes: detecting a deviation in an expected behavior of the first UAV; and determining to attribute the deviation in the expected behavior to an environmental condition.

15. The apparatus of any of the statements 11-14 wherein updating, by the environmental awareness controller, environmental condition information associated with the location to indicate a detection of the environmental condition at the location includes modifying an environmental awareness map.

16. A computer program product of increasing awareness of environmental conditions for an unmanned aerial vehicle (UAV), the computer program product disposed upon a non-transitory computer readable medium, the computer program product comprising computer program instructions that, when executed, cause a computer to carry out the operations of: utilizing, by an environmental awareness controller, data associated with a first UAV to detect an environmental condition at a location associated with the first UAV; updating, by the environmental awareness controller, environmental condition information associated with the location to indicate detection of the environmental condition at the location; and providing, by the environmental awareness controller, the updated environmental condition information to a device associated with a second UAV.

17. The computer program product of statement 16, wherein the data associated with the first UAV is based on sensor data generated by the first UAV.

18. The computer program product of any of the statements 16-17, wherein the data associated with the first UAV is based on sensor data generated by one or more other UAVs.

19. The computer program product of any of the statements 16-18, wherein utilizing, by an environmental awareness controller, data associated with a first UAV to detect an environmental condition at a location associated with the first UAV includes: detecting a deviation in an expected behavior of the first UAV; and determining to attribute the deviation in the expected behavior to an environmental condition.

20. The computer program product of any of the statements 16-19, wherein updating, by the environmental awareness controller, environmental condition information associated with the location to indicate a detection of the environmental condition at the location includes modifying an environmental awareness map.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for increasing awareness of an environmental condition for an unmanned aerial vehicle (UAV), the method comprising:
utilizing, by an environmental awareness controller, data associated with a first UAV to detect an environmental condition at a location associated with the first UAV;
updating, by the environmental awareness controller, environmental condition information associated with the location to indicate detection of the environmental condition at the location; and
providing, by the environmental awareness controller, the updated environmental condition information to a device associated with a second UAV.

2. The method of claim 1, wherein the data associated with the first UAV is based on sensor data generated by the first UAV.

3. The method of claim 1, wherein the data associated with the first UAV is based on sensor data generated by one or more other UAVs.

4. The method of claim 1, wherein utilizing, by an environmental awareness controller, data associated with a first UAV to detect an environmental condition at a location associated with the first UAV includes:
detecting a deviation in an expected behavior of the first UAV; and
determining to attribute the deviation in the expected behavior to an environmental condition.

5. The method of claim 1 wherein updating, by the environmental awareness controller, environmental condition information associated with the location to indicate a detection of the environmental condition at the location includes modifying an environmental awareness map.

6. The method of claim 1 wherein updating, by the environmental awareness controller, environmental condition information associated with the location to indicate a detection of the environmental condition at the location includes
determining whether an environmental awareness map indicates the detection of the environmental condition at the location; and
after determining that the environmental awareness map does not indicate a detection of the environmental condition at the location, updating the environmental information to indicate the detection of the environmental condition at the location.

7. A method of increasing awareness of environmental conditions for an unmanned aerial vehicle (UAV), the method comprising:
receiving from a device associated with a first UAV, by an environmental awareness controller, a request for environmental condition information for a location;
retrieving, by the environmental awareness controller, the environmental condition information from a repository of environmental condition information that indicates environmental conditions detected based on data associated with one or more other UAVs; and
providing, by the environmental awareness controller, the environmental condition information to the device associated with the first UAV.

8. The method of claim 7 further comprising:
utilizing, by the environmental awareness controller, data associated with a second UAV to detect an environmental condition at the location; and
updating, by the environmental awareness controller, the environmental condition information within the repository to indicate a presence of the environmental condition at the location.

9. The method of claim 8, wherein the data associated with the second UAV is based on sensor data generated by the first UAV.

10. The method of claim 8, wherein the data associated with the second UAV is based on sensor data generated by one or more other UAVs.

11. An apparatus for increasing awareness of environmental conditions for an unmanned aerial vehicle (UAV), the apparatus comprising:
a processor; and
a non-transitory computer readable medium storing instructions that when executed by the processor, cause the apparatus to carry out operations including:
utilizing, by an environmental awareness controller, data associated with a first UAV to detect an environmental condition at a location associated with the first UAV;
updating, by the environmental awareness controller, environmental condition information associated with the location to indicate detection of the environmental condition at the location; and
providing, by the environmental awareness controller, the updated environmental condition information to device associated with a second UAV.

12. The apparatus of claim 11, wherein the data associated with the first UAV is based on sensor data generated by the first UAV.

13. The apparatus of claim 11, wherein the data associated with the first UAV is based on sensor data generated by one or more other UAVs.

14. The apparatus of claim 11, wherein utilizing, by an environmental awareness controller, data associated with a first UAV to detect an environmental condition at a location associated with the first UAV includes:
detecting a deviation in an expected behavior of the first UAV; and
determining to attribute the deviation in the expected behavior to an environmental condition.

15. The apparatus of claim 11 wherein updating, by the environmental awareness controller, environmental condition information associated with the location to indicate a detection of the environmental condition at the location includes modifying an environmental awareness map.

16. A computer program product of increasing awareness of environmental conditions for an unmanned aerial vehicle (UAV), the computer program product disposed upon a non-transitory computer readable medium, the computer program product comprising computer program instructions that, when executed, cause a computer to carry out the operations of:
utilizing, by an environmental awareness controller, data associated with a first UAV to detect an environmental condition at a location associated with the first UAV;
updating, by the environmental awareness controller, environmental condition information associated with the location to indicate detection of the environmental condition at the location; and
providing, by the environmental awareness controller, the updated environmental condition information to a device associated with a second UAV.

17. The computer program product of claim 16, wherein the data associated with the first UAV is based on sensor data generated by the first UAV.

18. The computer program product of claim 16, wherein the data associated with the first UAV is based on sensor data generated by one or more other UAVs.

19. The computer program product of claim 16, wherein utilizing, by an environmental awareness controller, data associated with a first UAV to detect an environmental condition at a location associated with the first UAV includes:
detecting a deviation in an expected behavior of the first UAV; and
determining to attribute the deviation in the expected behavior to an environmental condition.

20. The computer program product of claim 16, wherein updating, by the environmental awareness controller, environmental condition information associated with the location to indicate a detection of the environmental condition at the location includes modifying an environmental awareness map.
